(19) United States
(12) Patent Application Publication
(10) Pub. No.: US 2022/0195721 A1
(43) Pub. Date: Jun. 23, 2022

(54) GLASS LAMINATE SOUND DIFFUSERS AND METHODS

(71) Applicant: CORNING INCORPORATED, CORNING, NY (US)

(72) Inventors: Eric Louis Null, Corning, NY (US); Prashanth Abraham Vanniamparambil, Ellicott, NY (US)

(21) Appl. No.: 17/601,746

(22) PCT Filed: Apr. 22, 2020
(86) PCT No.: PCT/US2020/029201

§ 371 Date: Oct. 6, 2021

Related U.S. Application Data
(60) Provisional application No. 62/841,172, filed on Apr. 30, 2019.

(51) Int. Cl. E04B 1/84; B32B 17/10; B32B 7/12

(52) U.S. Cl. CPC E04B 1/8409; B32B 17/10036; B32B 17/10541; B32B 7/12; B32B 2307/732; E04B 2001/8461; B32B 17/10137; B32B 17/10091; B32B 2307/102; E04B 2001/8414

(57) ABSTRACT

Transparent or translucent sound diffusers include a first glass sheet of less than 0.8 mm thickness and a second glass sheet of less than 0.8 mm thickness with a transparent or translucent adhesive layer there between, the adhesive layer adhering the first and second sheets in a fixed configuration such that a first major surface of the first glass sheet has a smooth, repeatedly rising and falling shape. The diffusers are secured to a wall or ceiling or to a wall or ceiling mount or to a wall or ceiling panel.

### CROSS-REFERENCE TO RELATED APPLICATIONS

This application claims the benefit of priority under 35 U.S.C. § 119 of U.S. Provisional Application No. 62/841,172, filed Apr. 30, 2019, the content of which is incorporated herein by reference in it entirety.

### FIELD OF THE DISCLOSURE

The disclosure relates to transparent or translucent glass laminate acoustic diffusers and to methods for preparing such acoustic diffusers.

### BACKGROUND

In most room acoustics applications, there is a need to achieve the right balance between acoustic reverberation and an acoustically dead room. This is typically achieved by using acoustic diffusers and absorbers. In acoustic diffusers, for compatibility with various rooms and room structures, particularly for smaller rooms, low weight and relative compactness are desirable.

### SUMMARY OF THE DISCLOSURE

According to some aspects of the present disclosure, a method of forming transparent or translucent sound diffuser is provided, the method comprising laminating a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof, to a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet, using a transparent or translucent adhesive layer between the second major surface of the first glass sheet and the first major surface of glass sheet, adhering the second major surface of the first glass sheet to the first major surface of the second glass sheet in a fixed configuration, such that the first major surface of the first glass sheet has a smooth, repeatedly rising and falling shape the first and second glass sheets and the adhesive layer between them forming a laminate structure; and securing the laminate structure to a wall or ceiling or to a wall or ceiling mount or to a wall or ceiling panel.

The can further comprise positioning a light source behind the second surface of the second glass sheet.

Either of the foregoing variations of the method can further comprise positioning a light source along an edge of the laminate structure, such as a light structure launching guided or partially-guided light into the laminate structure.

Any of the foregoing variations of the method can employ laminating which comprises holding the first glass sheet, the second glass sheet, and the polymer adhesive layer in a position corresponding to the fixed configuration while curing the polymer adhesive layer.

According to additional aspects of the present disclosure, a transparent or translucent sound diffuser is provided, the diffuser comprising a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof, and a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet, and a transparent or translucent adhesive layer between the second major surface of the first glass sheet and the first major surface of glass sheet adhering the second major surface of the glass sheet to the first major surface of the second glass sheet in a fixed configuration, such that the first major surface of the first glass sheet has a smooth, repeatedly rising and falling shape. The first and second glass sheets and the adhesive layer between them forming a laminate structure, and the laminate structure is secured to a wall or ceiling or to a wall or ceiling mount or to a wall or ceiling panel.

The diffuser can comprise a light source positioned behind the second surface of the second glass sheet.

The diffuser of either of the above aspects can comprise a light source positioned along an edge of the laminate structure.

In the diffuser of any of the above aspects the repeatedly rising and falling shape can be periodic.

In the diffuser of any of the above aspects the repeatedly rising and falling shape can be aperiodic.

In the diffuser of any of the above aspects the adhesive layer can comprise a polymer adhesive.

In the diffuser of any of the above aspects the adhesive layer can be colored at least in part.

In the diffuser of any of the above aspects at least the first glass sheet can be an aluminosilicate glass.

In the diffuser of any of the above aspects at least the first glass sheet can be a boro-aluminosilicate glass.

In the diffuser of any of the above aspects at least the first glass sheet can be an unstrengthened glass sheet.

In the diffuser of any of the above aspects at least the first glass sheet can be a chemically strengthened glass sheet.

In the diffuser of any of the above aspects at least the first glass sheet is a thermally strengthened glass sheet.

Additional features and advantages will be set forth in the detailed description which follows and will be apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure.

It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a brief description of the figures in the accompanying drawings. The figures are not necessarily to scale, and certain features and certain views of the figures may be shown exaggerated in scale or in schematic in the interest of clarity and conciseness.

In the drawings:

FIG. 1 is a perspective view illustrating steps of a process according to at least one embodiment of the disclosure;

FIG. 2 is a perspective view illustrating a laminate structure according to at least one embodiment of the disclosure;

FIG. 3 is a is a perspective view of the laminate structure of FIG. 2 secured to a wall or ceiling or to a wall or ceiling mount or to a wall or ceiling panel;

FIG. 4 is a perspective view showing an embodiment of some products according to the disclosure; and

FIG. 5 is a perspective view showing an additional embodiment of some products according to the disclosure.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

In general, the disclosure is directed to transparent or translucent glass acoustic diffusers and methods of forming such.

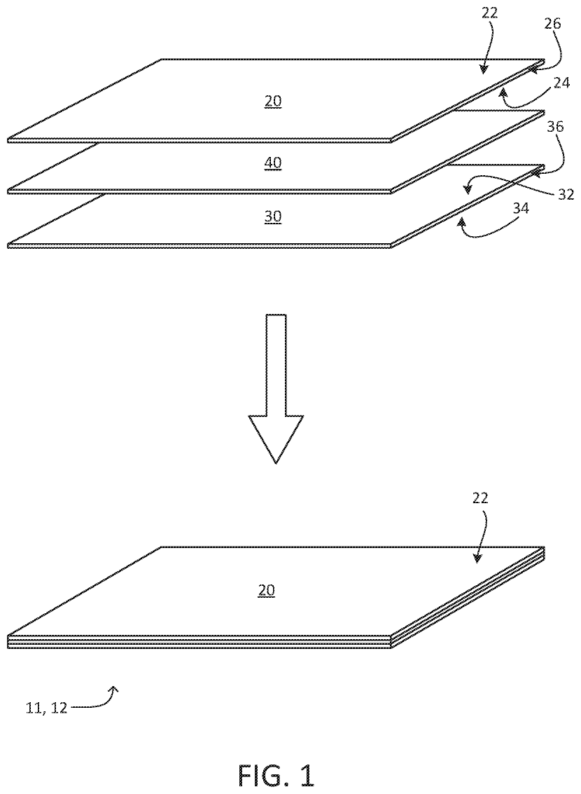

According to embodiments and with reference to FIGS. 1-3, a method for forming a transparent or translucent glass-containing diffuser comprises laminating a first glass sheet 20 having a first major surface 22 and a second major surface 24 connected by an edge surface 26, and a thickness measured from the first major surface to the second major surface of less than 0.8 mm, to a second glass sheet 30 having first and second major surfaces 32, 34 connected by an edge surface 36 and a thickness measured from the first major surface to the second major surface of less than 0.8 mm.

The edge surface 26 of the first glass sheet 20 has a shape, when viewed in a direction generally normal to the first major surface 22 thereof, and the second glass sheet 30 has a shape, when viewed in a direction generally normal to the first major surface 32 thereof, generally matching the shape of the first glass sheet. The first glass sheet 20 and the second glass sheet 30 are laminated to each other using a transparent or translucent adhesive layer 40 positioned between the second major surface 24 of the first glass sheet 20 and the first major surface 32 of the second glass sheet 30, adhering the second major surface 24 of the first glass sheet 20 to the first major surface 32 of the second glass sheet 30 in a fixed configuration, such that the first major surface 22 of the first glass sheet 20 has a smooth, repeatedly rising and falling shape (such as shown in FIG. 3).

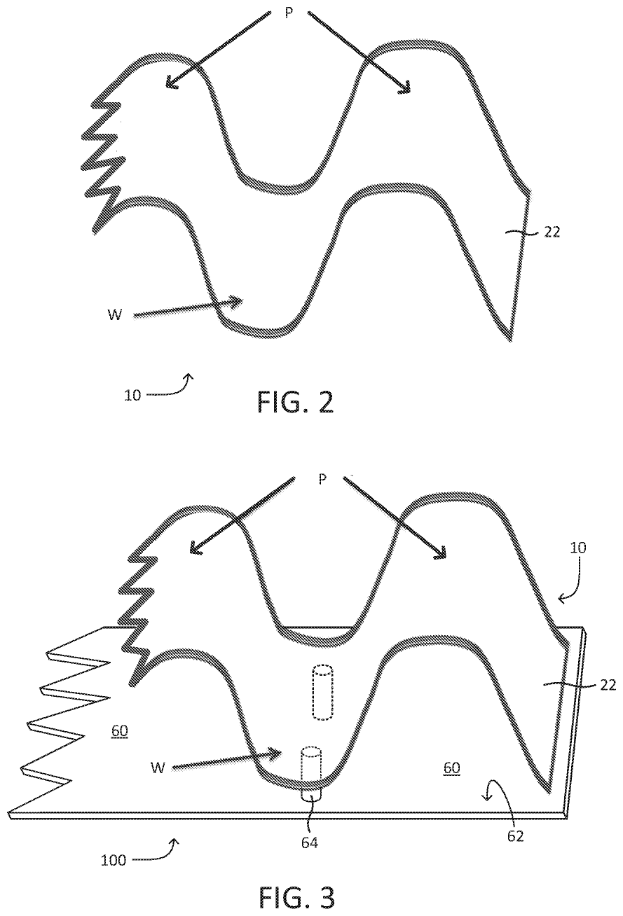

This may be achieved by stacking the first and second glass sheets 20, 30 with the adhesive layer 40 as illustrated in FIG. 1 to form a stack 11, then forming the stack 11 together in a mold or in other fixture (not shown) to impose a shape such as the one shown in FIG. 3, while curing or otherwise setting the adhesive layer 40 to form a laminated structure 10 as in FIG. 2. Alternatively, in the case of an adhesive layer which is thermoplastic, for example, the adhesive layer may optionally be set and the laminating first completed in a flat configuration as shown at the bottom of FIG. 1 to form a flat limited structure 12, and the flat laminated structure 12 may be reformed, using a mold or other fixture, by holding the flat laminated structure in a shape—or gradually bringing the flat laminated structure to a shape—such as the shape shown in FIG. 2, while heating the laminated structure then allowing it to cool, such that a laminated structure 10 such as the one of FIG. 2 results, once the mold or other fixturing is removed. Either way, a laminated structure 10 is produced where the upper surface 22 of the sheet 20 has a periodic shape with one or more wells W and protrusions P alternating along the laminate structure 10.

The method further comprises securing the laminate structure to a wall or ceiling (not shown) or to a wall or ceiling mount 64 or to a wall or ceiling panel 60.

The resulting product, an embodiment of which is represented in FIG. 3, is a transparent or translucent structure for sound diffusing, with the structure comprising: (1) a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof; (2) a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet; and (3) a transparent or translucent adhesive layer between the second major surface of the first glass sheet and the first major surface of glass sheet adhering the second major surface of the glass sheet to the first major surface of the second glass sheet in a fixed configuration, such that the first major surface of the first glass sheet has a smooth, repeatedly rising and falling shape, the first and second glass sheets and the adhesive layer between them forming a laminate structure; wherein the laminate structure is secured to a wall or ceiling or to a wall or ceiling mount or to a wall or ceiling panel.

Desirably, glass sheets 20, 30 having even lower thickness may be used, such as glass sheets having a thickness within the range of from 0.05 mm to 0.8 mm, or 0.1 mm to 0.75 mm, or from 0.1 mm to 0.7 mm, or from 0.1 mm to 0.6 mm, or from 0.1 mm to 0.55 mm, or from 0.1 mm to 0.5 mm, or within any one of the above ranges but with a lower bound of 0.15 mm, 0.2 mm, or even 0.3 mm.

In use, the structure 10 of FIG. 3 is mounted near an architectural surface, such as surface 62 of a wall, ceiling, or architectural (wall or ceiling) panel 60, as shown in FIG. 3. Alternatively, the product itself may take the form of the structure 10 mounted on or near the surface 62 of the panel 60, as shown, resulting in a mounted structure 100. The well(s) W and the protrusions P of the rising and falling shape of the surface 22 provide an acoustic dispersing function, the frequency response of which can be tuned by adjusting the shape(s) and size(s) of the well(s) W and protrusions P. Thus the structure 10 of FIG. 3 constitutes a transparent (or translucent) acoustic diffuser. Use of the glass-based laminate structure 10 in this manner, particularly with relatively thin glass sheets, provides an acoustic diffuser which is thin, light weight, and aesthetically pleasing while remaining sufficiently stiff to reduce undesirable resonance.

As shown in FIG. 3, the structure 10 can be mounted to the surface 62 by a plurality of posts 64. Alternatively, the structure 10 can be adhered directly to the surface 62 via a suitable adhesive (not shown) or can be mounted at an offset from or in contact with the surface 62 by other suitable means.

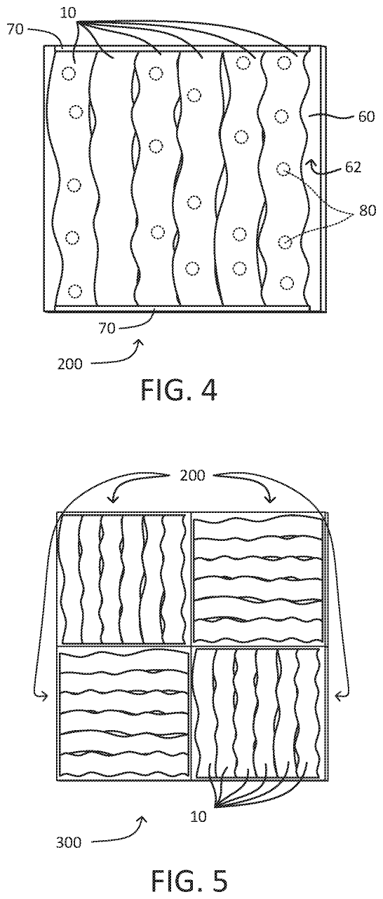

According to further embodiments, multiple structures 10 can be mounted near or directly adjacent each other, such as in the configuration shown in FIG. 4, resulting in a structure 200 comprising multiple structures 10.

According to embodiments, the structure 10 or the mounted structure 100 or the structure 200 can comprise one or more light sources 70 positioned at the edge surface 26 of the first glass sheet 20 and/or at the edge surface 36 of the second glass sheet 30 (or both), as shown in the embodiment of FIG. 4. According to still further embodiments, and if desired, in any combination with other embodiments, a light source 80 or one or more light sources 80 may be included, positioned behind the second surface 34 of the second glass sheet 30. These embodiments may be particularly beneficial for smaller rooms in that one room element can serve as both a lighting element and an acoustic diffuser, providing extra compactness by combining functions.

According to still further embodiments and as shown in FIG. 5, multiple structures 200 may be mounted in combination to form a structure 300 comprising a plurality of structures 200 having more than one orientation.

According to embodiments, and in combination with any of the other embodiments or aspects, the repeatedly rising and falling shape of the surface 22 can be periodic. Alternatively, the repeatedly rising and falling shape of the surface 22 can be aperiodic.

According to embodiments, and in combination with any of the other embodiments or aspects, the adhesive layer comprises a polymer adhesive. The polymer adhesive can comprise a PVB (polyvinyl butyral) material, and can comprise a low-plasticizer PVB (polyvinyl butyral) material. Alternatively, the polymer adhesive can comprise an EVA (ethylene-vinyl acetate copolymer) material. Alternatively, the polymer adhesive can comprise an ionoplast material, such as Sentryglas® interlayer material, available from DuPont. Desirably the ionoplast such as Sentryglas material comprises ethylene/methacrylic acid copolymers with small amounts of metal salts, and desirably has a Young's modulus of greater than 100 MPa at temperatures up to 50° C.

According to embodiments, and in combination with any of the other embodiments or aspects, the adhesive layer can be colored at least in part, or opaque at least in part, translucent (and not transparent) at least in part, or any combination of these. According to embodiments, and in combination with any of the other embodiments or aspects, at least the first glass sheet can comprise an aluminosilicate glass, or a boro-aluminosilicate glass.

According to embodiments, and in combination with any of the other embodiments or aspects, at least the first glass sheet can be an unstrengthened glass sheet. Alternatively, according to embodiments and in combination with any of the other embodiments or aspects, at least the first glass sheet can be a chemically strengthened glass sheet or a thermally strengthened glass sheet or a sheet strengthened by a combination of chemical and thermal processes.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A transparent or translucent sound diffuser, the diffuser comprising:
a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof;
a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet; and
a transparent or translucent adhesive layer between the second major surface of the first glass sheet and the first major surface of glass sheet adhering the second major surface of the glass sheet to the first major surface of the second glass sheet in a fixed configuration, such that the first major surface of the first glass sheet has a smooth, repeatedly rising and falling shape, the first and second glass sheets and the adhesive layer between them forming a laminate structure;
wherein the laminate structure is secured to a wall or ceiling or to a wall or ceiling mount or to a wall or ceiling panel.

2. The diffuser of claim 1 wherein the laminate structure is secured to a wall or ceiling panel.

3. The diffuser of claim 1 further comprising a light source positioned behind the second surface of the second glass sheet.

4. The diffuser of claim 1 further comprising a light source positioned along an edge of the laminate structure.

5. The diffuser of claim 1 wherein the repeatedly rising and falling shape is periodic.

6. The diffuser of claim 1 wherein the repeatedly rising and falling shape is aperiodic.

7. The structure of claim 1 wherein the adhesive layer comprises a polymer adhesive.

8. The structure of claim 1 wherein the adhesive layer is colored at least in part.

9. The structure of claim 1 wherein at least the first glass sheet comprises an aluminosilicate glass.

10. The structure of claim 1 wherein at least the first glass sheet comprises a boro-aluminosilicate glass.

11. The structure of claim 1 wherein at least the first glass sheet is an unstrengthened glass sheet.

12. The structure of claim 1 wherein at least the first glass sheet is a chemically strengthened glass sheet.

13. The structure of claim 1 wherein at least the first glass sheet is a thermally strengthened glass sheet.

14. A method of forming transparent or translucent sound diffuser, the method comprising:
laminating a first glass sheet having a first major surface and a second major surface connected by an edge surface and a thickness measured from the first major surface to the second major surface of less than 0.8 mm, the edge surface of the first glass sheet having a shape, when viewed in a direction generally normal to the first major surface thereof, to a second glass sheet having first and second major surfaces connected by an edge surface and a thickness measured from the first major surface to the second major surface of less than 0.8 mm, the edge surface of the second glass sheet having a shape, when viewed in a direction generally normal to the first major surface thereof, generally matching the shape of the first glass sheet, using a transparent or translucent adhesive layer between the second major surface of the first glass sheet and the first major surface of glass sheet adhering the second major surface of the first glass sheet to the first major surface of the second glass sheet in a fixed configuration, such that the first major surface of the first glass sheet has a smooth, repeatedly rising and falling shape the first and second glass sheets and the adhesive layer between them forming a laminate structure; and
securing the laminate structure to a wall or ceiling or to a wall or ceiling mount or to a wall or ceiling panel.

15. The method of claim 14 further comprising positioning a light source behind the second surface of the second glass sheet.

16. The method of claim 14 further comprising positioning a light source along an edge of the laminate structure.

17. The method of claim 14 wherein laminating further comprises holding the first glass sheet, the second glass sheet, and the polymer adhesive layer in a position corresponding to the fixed configuration while curing the polymer adhesive layer.
